(19) United States
(12) Patent Application Publication
(10) Pub. No.: US 2011/0036648 A1
(43) Pub. Date: Feb. 17, 2011

(54) Notebook Mountable Hand Writing Memory System

(75) Inventors: Wei-Chou Chen, Hsin-Chu (TW); Cheng-Lu Liu, Hsin-Chu (TW); Yun-Hsiang Yeh, Miaoli (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, Hsinchu (TW)

(21) Appl. No.: 12/694,670

(22) Filed: Jan. 27, 2010

(30) Foreign Application Priority Data
Aug. 11, 2009 (TW) 098214797

(51) Int. Cl. G06F 3/041

(52) U.S. Cl. 178/18.03

(57) ABSTRACT

A notebook mountable hand writing memory system is disclosed, and particular disclosed a notebook mountable tablet. In the notebook mountable hand writing memory system, a top protective layer, a sensing board and a bottom protective layer is assembled to form the writing member of the notebook mountable hand writing memory system for reducing the weight and the thickness of the notebook mountable hand writing memory system. Therefore, the notebook mountable hand writing memory system has the characteristics of low fabricating cost, low weight, and thinner thickness. Furthermore, a plurality of through holes are provided on the writing member for integrating the notebook mountable hand writing memory system with a conventional notebook. Therefore, the information written on the paper of the conventional notebook can be digitized and stored by the notebook mountable hand writing memory system.

### FIELD OF THE INVENTION

The present invention relates to a notebook mountable hand writing memory system, and particularly relates to a notebook mountable tablet.

### BACKGROUND OF THE INVENTION

With the development of electronics, electronic notebooks are used instead of conventional notebooks made of papers gradually. Most of the present electronic notebooks adopt the electromagnetic induction technology. These electronic notebooks have a sensing board is made of one or more inductive loop, and an electromagnetic pen which can emits electromagnetic signals and has a marker capable of outputting ink to write on a paper. By the sensing board and the electromagnetic pen, when the information is wrote on the paper, the information wrote on the paper can be digitized and stored at the same time. When the electromagnetic pen is writing on the paper with marker, the electromagnetic pen emits electromagnetic signals simultaneously. And then, the inductive loop receives the electromagnetic signals emitting from the electromagnetic pen and the electronic notebook finds the position and the moving trace of the electromagnetic pen according to the electromagnetic signals which the inductive loop receives, and the position and the moving trace are stored in a memory of the electronic notebook. By this way, the information can be written on the paper and stored in memory simultaneously.

Referring to FIGS. 1A and 1B, they are respectively a stereoscopic form diagram and a cross-section view diagram illustrating the appearance and the cross-section structure of a conventional electronic notebook 10. FIG. 1B is the cross-section view diagram illustrating cross-section structure of the conventional electronic notebook 10 showed in FIG. 1A, which is cut along the line AA′. The conventional electronic notebook 10 comprises a sensing board 12, an electromagnetic pen 13, a control board 18, a connecting bus 20, and a housing 16. The control board 18, the connecting bus 20, and the sensing board 12 are placed in the housing 16 from lower to upper in order and they are covered by the housing 16. The control board 18 is electrically connected with the sensing board 12 by the connecting bus 20. Furthermore, the housing 16 has a cavity 14 thereon for putting a paper on the sensing board 12 to write. Or in some conventional electronic notebooks, they do not have the cavity 14 and a paper is put directly on sensing board for writing. The electromagnetic pen 13 can emit electromagnetic signals and it has a marker for outputting ink to write. When the marker of the electromagnetic pen 13 outputs ink to write on a paper, the electromagnetic pen 13 emits the electromagnetic signals to the sensing board 12 simultaneously for the sensing board 12 to record the position of the electromagnetic pen 13. Therefore, the information (for example words, drawing or etc.) written on the conventional electronic notebook 10 is digitized and stored by this way.

However, all of above-mentioned conventional electronic notebooks are heavy because all of them need a big and heavy housing to contain the control board, the connecting bus and the sensing board. Besides, all of above-mentioned conventional electronic notebooks can not be integrated with a conventional notebook made of papers, so the papers (or the conventional notebook made of papers) and the conventional electronic notebook are carried separately. When writing, the paper (or the paper of the conventional notebook made) is taken and then it is put on the conventional electronic notebook. So it is inconvenient to use by this way and the conventional electronic notebook is not convenient to be carried and used as a notebook.

Therefore, in view of foregoing drawbacks of conventional electronic notebook, there is a need to provide a notebook mountable hand writing memory system with the characteristics of low weight and thinner thickness and with the ability to be integrated with a notebook.

### SUMMARY OF THE INVENTION

An objective of this invention is to provide a notebook mountable hand writing memory system with the characteristics of low weight and thinner thickness and with the ability to be integrated with a conventional notebook. The notebook mountable hand writing memory system is convenient to be carried and used, and it is capable of digitizing and storing the information written on the notebook mountable hand writing memory system immediately and simultaneously when the information is wrote on a notebook.

In one embodiment of the present invention, a notebook mountable hand writing memory system is disclosed and the notebook mountable hand writing memory system is easy to be integrated with a notebook for be conveniently used and carried. The notebook mountable hand writing memory system comprises a digital system for controlling the notebook mountable hand writing memory system, a pointing device for writing and inputting on a paper and the notebook mountable hand writing memory system, a writing member for sensing the pointing device and for placing a paper thereon to write and input, and a plurality of through holes formed on the writing member. The through holes are the holes passing through the writing member, and fixing rings can pass through the through holes. Therefore, papers can be held and fixed on the writing member by assembling the through holes and the fixing rings. It means that the fixing rings pass through both of the holes on the papers and the through holes of writing member to hold them together and to hold and fix the papers on the writing member. By the through holes and fixing rings, the papers and the notebook mountable hand writing memory system can be integrated with each other to form a notebook. The notebook mountable hand writing memory system is integrated with a conventional notebook made of papers by the through holes and fixing rings, so it is convenient to be used and carried and it is capable of digitizing and storing the information wrote on the notebook mountable hand writing memory system immediately and simultaneously when the information is wrote on the notebook. Besides, a top protective layer and a bottom protective layer are directly attached on the top surface and the bottom surface of the sensing board respectively to form the writing member. Therefore, comparing with the housing of the conventional electronic notebook, the housing of the notebook mountable hand writing memory system is significantly reduced. It makes the notebook mountable hand writing memory system to become lighter, thinner and the fabricating cost of the notebook mountable hand writing memory system to be reduced.

Therefore, the effect achieved with the present invention is to provide a notebook mountable hand writing memory system with the characteristics of low weight and thinner thickness wherein some through holes are formed the writing member of the notebook mountable hand writing memory system. As a consequence of this structure of notebook mountable hand writing memory system, the notebook mountable hand writing memory system can be integrated with a conventional notebook by assembling the through holes and fixing rings for being conveniently used and carried.

### BRIEF DESCRIPTION OF THE DRAWINGS

FIGS. 1A and 1B are respectively a stereoscopic form diagram and a cross-section view diagram respectively illustrating the appearance and the structure of a conventional electronic notebook.

FIGS. 2A, 2B and 2C are respectively a stereoscopic form diagram, a cross-section view diagram and a stereoscopic form diagram illustrating the appearance, the cross-section structure and the inner structure of a notebook mountable hand writing memory system in accordance with one embodiment of the present invention.

FIG. 3 is a plan view diagram illustrating a notebook mountable hand writing memory system in accordance with another embodiment of the present invention.

FIGS. 4A and 4B are respectively a cross-section view diagram and a stereoscopic form diagram illustrating the cross-section structure and the appearance of a notebook mountable hand writing memory system in accordance with still another embodiment of the present invention.

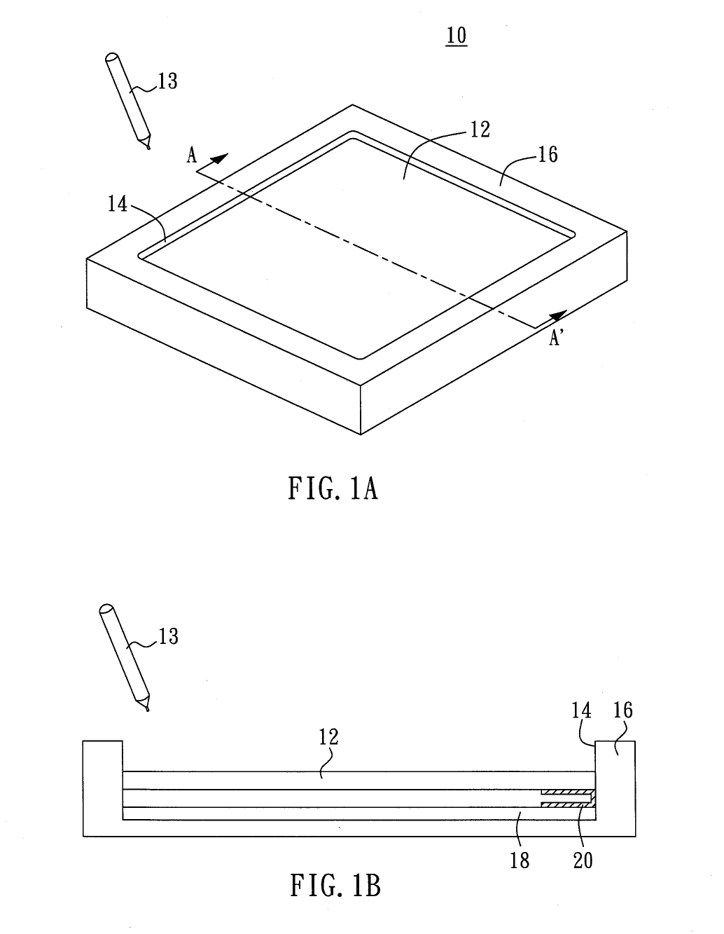

### DESCRIPTION OF THE EXEMPLARY EMBODIMENTS

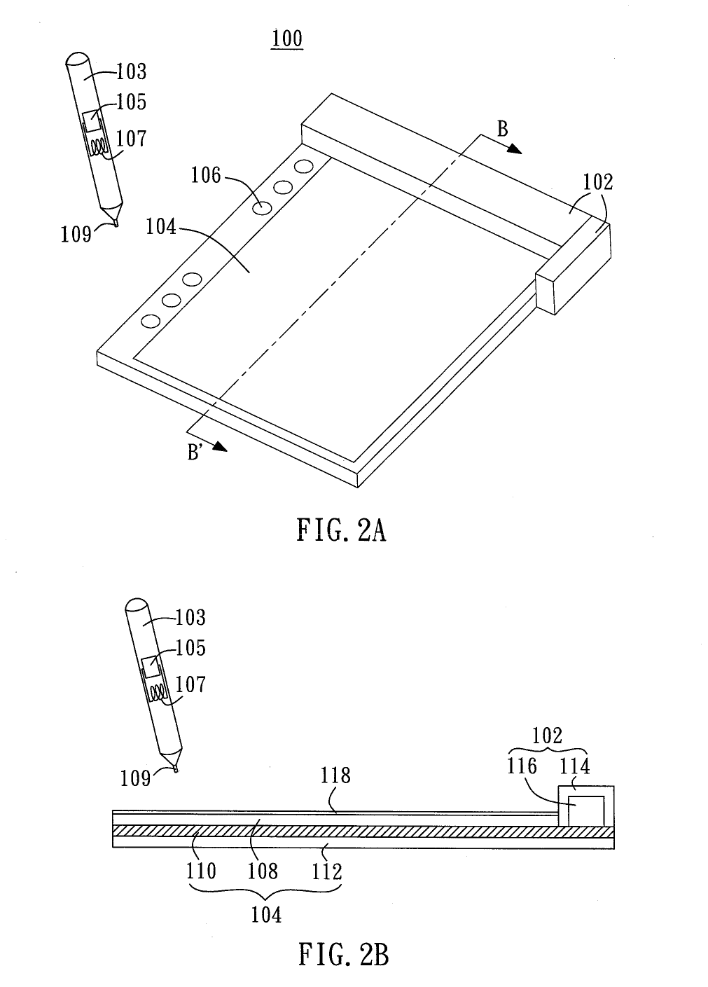

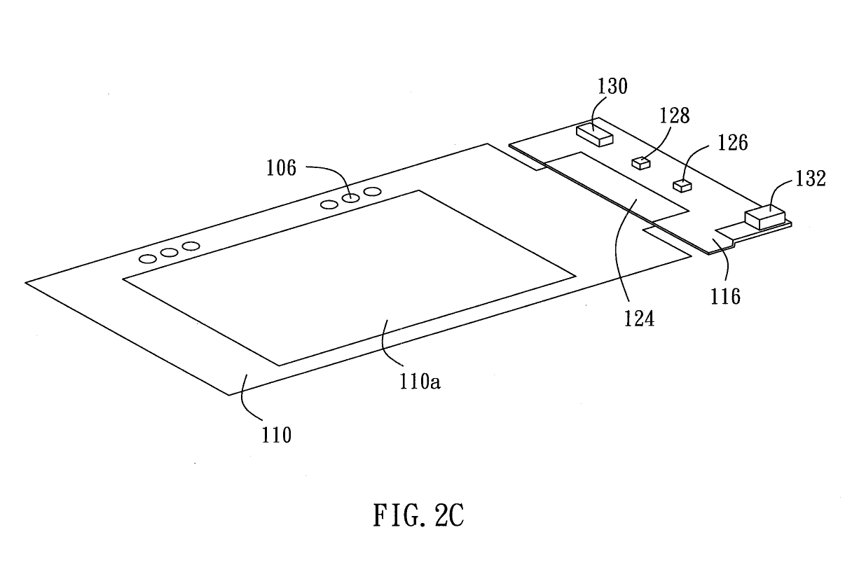

Referring to FIGS. 2A, 2B and 2C, they are respectively a stereoscopic form diagram, a cross-section view diagram and a stereoscopic form diagram illustrating the appearance, the cross-section structure and the inner structure of a notebook mountable hand writing memory system 100 in accordance with one embodiment of the present invention. FIG. 2B is the cross-section view diagram illustrating cross-section structure of the notebook mountable hand writing memory system 100 showed in FIG. 2A, which is cut along the line BB′. FIG. 2C is the stereoscopic form diagram illustrating the inner structure of the notebook mountable hand writing memory system 100 showed in FIG. 2A. The notebook mountable hand writing memory system 100 is a notebook mountable tablet capable of being integrated with a conventional notebook. The notebook mountable hand writing memory system 100 comprises a digital system 102 for controlling the notebook mountable hand writing memory system 100, a pointing device 103 for writing and inputting on a paper 118 and the notebook mountable hand writing memory system 100, a writing member 104 for sensing the pointing device 103 and for placing a paper 118 thereon to write and input, and a plurality of through holes 106 formed on the writing member 104. The through holes 106 pass through the writing member 104 for the fixing rings to pass through the through holes 106 so the paper 118 is connected with the writing member 104 and the paper 118 is held and fixed on the writing member 104. By assembling the through holes 106 and the fixing rings, the notebook mountable hand writing memory system 100 can be connected with more papers to for a notebook with a mountable tablet, or the notebook mountable hand writing memory system 100 can be directly connected with a loose-leaf notebook to form conventional notebook with the notebook mountable hand writing memory system 100. Therefore, the notebook mountable hand writing memory system 100 is convenient to be used and carried.

The writing member 104 comprises a top protective layer 108, a sensing board 110 and a bottom protective layer 112, and the writing member 104 consists of above-mentioned three members. The top protective layer 108 is adhered to the top surface of the sensing board 110 and the bottom protective layer 112 is adhered to the bottom surface of the sensing board 110. Therefore, the sensing board 110 is positioned between the top protective layer 108 and the bottom protective layer 112, and the sensing board 110 is sandwiched in between the top protective layer 108 and the bottom protective layer 112. The through holes 106 on the writing member 104 pass through all of the top protective layer 108, the sensing board 110, and the bottom protective layer 112. The sensing board 110 comprises an inductive area 110a deposed therein and the inductive area 110a has at least one inductive loop disposed therein for sensing the electromagnetic signals emitting form the pointing device 103 (as FIG. 2C shows). The through holes 106 pass through the area aside the inductive area 110a for avoiding breaking or damaging the inductive loop, wherein there is no any inductive loop deposed in this area. The sensing board 110 can be made of a hard print circuit board, a flexible print circuit board or a thin film, and the top protective layer 108 and the bottom protective layer 112 are made of a plastic material, a rubber or a silica gel. A silicon steel can deposed in the bottom protective layer 112 for reflecting the electromagnetic signals emitted from pointing device 103 in order to enhance the sensing board 110 to induce the electromagnetic signals. Furthermore, a copper foil can be deposed in the bottom protective layer 112 for preventing the sensing board 110 from external interference. Or both of the silicon steel and the copper foil can be deposed in the bottom protective layer 112 for enhancing the sensing board 110 to induce the electromagnetic signals and preventing the sensing board 110 from external interference simultaneously.

The digital system 102 consists of a housing 114 and a system member 116 wherein the housing 114 covers the system member 116 for protecting the system member 116 from damage and break. Referring to FIG. 2C, the system member 116 comprises a signal processing unit 126, a memory unit 128, a power unit 130, and a signal interface unit 132. The signal processing unit 126 is used for processing the electromagnetic signals sensed or received by said writing member 104, wherein the electromagnetic signals are emitted from the pointing device 103. Furthermore, the signal processing unit 126 calculates or finds the position and the moving trace of the pointing device 103 on the writing member 104 according to the electromagnetic signals. The memory unit 128 is used for storing the information inputted by the pointing device 103. It means that the position and the moving trace of the pointing device 103 on the writing member 104, which are calculated and processed by the signal processing unit 126 according to the electromagnetic signals, is stored in the memory unit 128. The power unit 130 is used for supplying power to the notebook mountable hand writing memory system 100 to operate. The signal interface unit 132 is used for connecting the notebook mountable hand writing memory system 100 with an external system or an external device. The notebook mountable hand writing memory system 100 connects with an external system or an external device by the signal interface unit 132 (for example a universal serial bus interface (USB interface)), so the information stored in the notebook mountable hand writing memory system 100 can be transmitted the external system or the external device. Or the notebook mountable hand writing memory system 100 connects with an external power supply for supplying power to the notebook mountable hand writing memory system 100 to operate.

Referring FIG. 2C, in this embodiment, the system member 116 is a control board with the signal processing unit 126, the memory unit 128, the power unit 130, and the signal interface unit 132 deposed thereon. The signal processing unit 126 is a microprocessor or a central processing unit (CPU). The power unit 130 is a battery or a battery container for placing a battery thereon or therein. The signal interface unit 132 is a universal serial bus interface or port (USB interface or port) which a universal serial bus can be insert in for connecting with the external system or the external device.

The housing 114 and the system member 116 are deposed on the sensing board 110 as FIG. 2B shows, or the sensing board 110 is substantially and electrically connected with the system member 116 by a connecting member 124 as FIG. 2C shows, for example a connecting bus. No matter which method for connecting the sensing board 110 with the system member 116 is adopted, both of the sensing board 110 and the system member 116 is supported by the bottom protective layer 112. Therefore, the bottom protective layer 112 supports and carries all elements in the notebook mountable hand writing memory system 100. It means that the bottom protective layer 112 is the lowest layer or the bottom of the notebook mountable hand writing memory system 100.

The pointing device 103 is an electromagnetic pen. The electromagnetic pen comprises a coil 105 and a circuit 107 for emitting electromagnetic signals and a marker 109 for outputting ink to write. When a paper is held and fixed on the notebook mountable hand writing memory system 100 by assembling the through holes 106 deposed on the writing member 104 and the fixing rings, the marker 109 of the pointing device 103 outputs the ink to write on the paper. At the same time, the writing member 104 records the position and the moving trace of the pointing device 103 on the notebook mountable hand writing memory system 100 by inducing the electromagnetic signals. Therefore, the information (for example words, drawing, or etc.) wrote on the paper with ink is digitized and stored by this way. Or a plurality of papers can be connected with the notebook mountable hand writing memory system 100 by assembling the through holes 106 and the fixing rings to form a notebook, so the notebook mountable hand writing memory system 100 becomes one of the pages of the notebook. Or the notebook mountable hand writing memory system 100 is directly connected with a conventional notebook by assembling the through holes 106 and the fixing rings to be an inner page of the conventional notebook.

Besides, the writing member 104 is formed by adhering the top protective layer 108 and the bottom protective layer 112 respectively to the top surface and the bottom surface of sensing board 110. Therefore, only the system member 116 of the notebook mountable hand writing memory system 100 needs a cover to be the housing 114 for protecting the system member 116 from break and damage. As a consequence of above-mentioned structure, the housing which the notebook mountable hand writing memory system 100 requires is significantly smaller than the housing which the conventional electronic notebook requires. Comparing with the conventional electronic notebook, the thickness and weight of the notebook mountable hand writing memory system 100 are significantly reduced because the size of the heavy and thick housing is reduced and minimized. Accordingly, the fabricating cost of the notebook mountable hand writing memory system 100 is decreased efficiently because the size of the housing which the notebook mountable hand writing memory system 100 requires is reduced.

Although, in foregoing embodiments, only one notebook mountable hand writing memory system 100 is used to be integrated with a conventional notebook to be one of the inner pages of the conventional notebook and is used for digitizing and storing the information wrote on the notebook, but in other embodiments, two or more notebook mountable hand writing memory system can be integrated with a conventional notebook to be the inner pages of the conventional notebook.

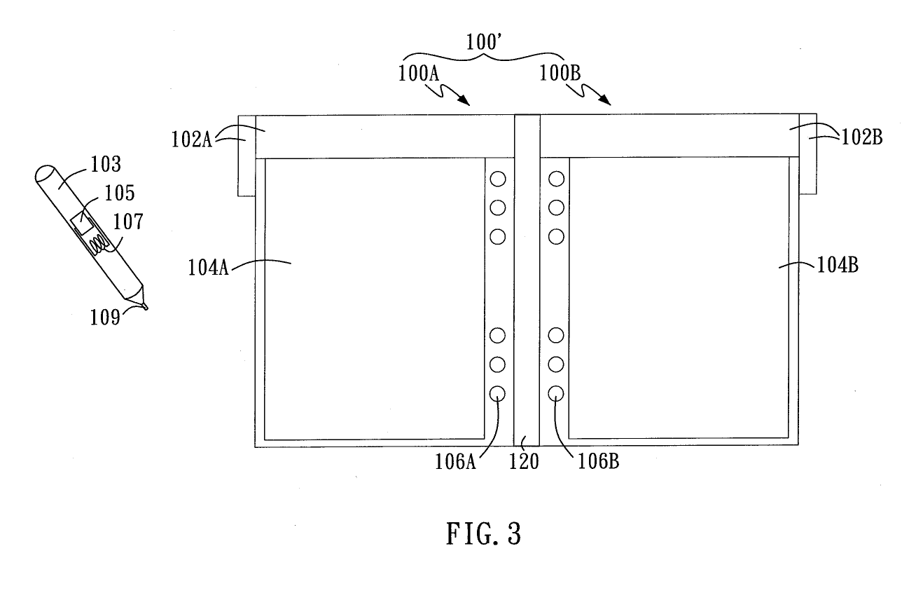

Referring to FIG. 3, it is a plan view diagram illustrating a notebook mountable hand writing memory system 100′ in accordance with another embodiment of the present invention. The notebook mountable hand writing memory system 100′ consists of two notebook mountable hand writing memory systems 100A and 100B, and the two notebook mountable hand writing memory systems 100A and 100B are connected with each other by a combining member 120. The combining member 120 is made of a soft material, for example a soft plastic material, a rubber or a silica gel. Therefore, the two notebook mountable hand writing memory systems 100A and 100B form a standard-sized inner page of a conventional notebook by the combining member 120 as a standard-sized sheet. It means that the two notebook mountable hand writing memory systems 100A and 100B are the two opposite inner pagers of the conventional notebook, and papers or inner pages of the conventional notebook are connected and sandwiched in between the two notebook mountable hand writing memory systems 100A and 100B. Therefore, no matter which side of the conventional notebook the inner pages or the papers are placed on, a user can write on any of the inner pages or the papers and the information wrote by the user can be digitized and stored simultaneously. Both of the sides of the two notebook mountable hand writing memory systems 100A and 100B, which are adjacent to each other, have through holes 106A and 106B. Papers or a conventional notebook is connected with the notebook mountable hand writing memory system 100′ and sandwiched in between the two notebook mountable hand writing memory systems 100A and 100B by assembling the through holes 106A, 106B and fixing rings, so the papers or the inn pages can be placed respectively on the two sides of the notebook mountable hand writing memory system 100′ for writing. Or the notebook mountable hand writing memory system 100′is integrated with a conventional notebook to be a standard-sized inner page of the conventional notebook for digitizing and storing the information wrote on the inner page of the conventional notebook by a user.

Both of the two notebook mountable hand writing memory systems 100A and 100B comprise a digital system 102A, 102B and a writing member 104A, 104B. The structure of them and the material which they are made of are the same with the foregoing notebook mountable hand writing memory system 100 so they are not mentioned herein again. Both of the two notebook mountable hand writing memory systems 100A and 100B comprise a pointing device 103 for writing on the paper placed on the two notebook mountable hand writing memory systems 100A and 100B and inputting the information to the two notebook mountable hand writing memory systems 100A and 100B. The pointing device 103 comprises a coil 105 and a circuit 107 for emitting electromagnetic signals and a marker 109 for outputting ink to write. The structure of the pointing device 103 has detailed before and it is not mentioned herein again.

Furthermore, in the notebook mountable hand writing memory system of the present invention, a holding device can be deposed on at least one side of the notebook mountable hand writing memory system for holding and fixing papers on the writing member without move and slide. Therefore, when a user writes on the paper putted on writing member by the pointing device, the paper will not move or slide.

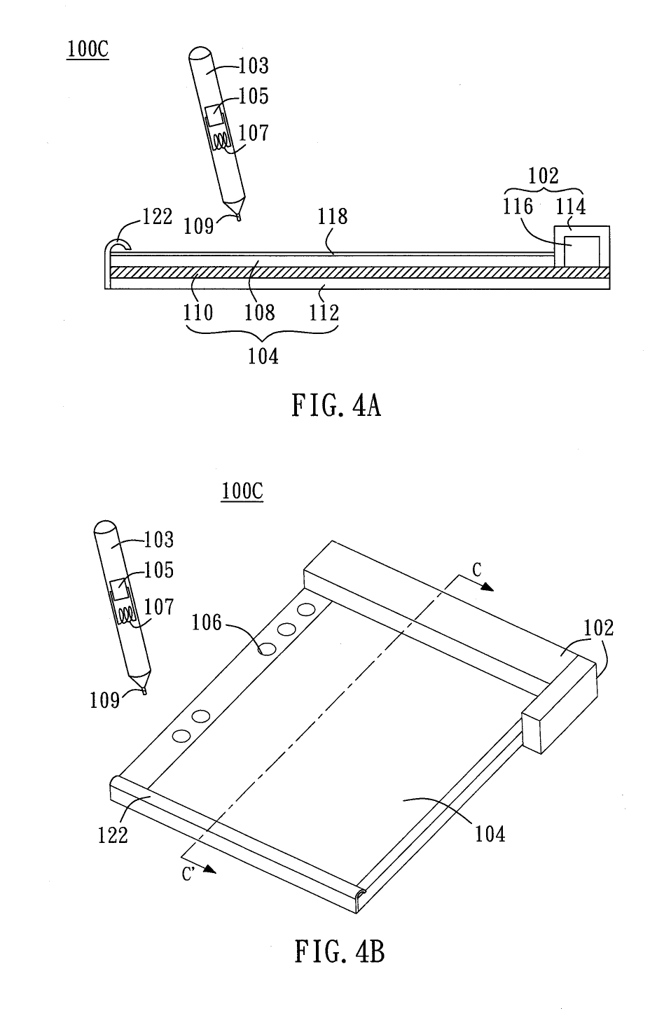

Referring to FIGS. 4A and 4B, they are respectively a cross-section view diagram and a stereoscopic form diagram illustrating the cross-section structure and the appearance of a notebook mountable hand writing memory system 100C in accordance with still another embodiment of the present invention. FIG. 4B is the cross-section view diagram illustrating cross-section structure of the notebook mountable hand writing memory system 100C showed in FIG. 4A, which is cut along the line CC′. The notebook mountable hand writing memory system 100C comprises a digital system 102, a pointing device 103, a writing member 104 and several through holes 106 formed on the writing member 104, as the notebook mountable hand writing memory system 100 showed in FIGS. 2A and 2B. The elements of the notebook mountable hand writing memory system 100C which are the same with the elements of the notebook mountable hand writing memory system 100 have detailed before, so they are not mentioned herein again. The difference between the two notebook mountable hand writing memory systems 100C and 100 is that the notebook mountable hand writing memory system 100C has the holding device 122 deposed at one side of the notebook mountable hand writing memory system 100C. In the notebook mountable hand writing memory system 100C, the holding device 122 is a batten made by reversely bending one side of the notebook mountable hand writing memory system 100C for holding and fixing a paper on the writing member 104 when a user writes on the paper.

However, in another embodiment, a binder or other device capable of holding and fixing a paper on the writing member can be deposed at one side of the notebook mountable hand writing memory system to be a holding device. Furthermore, in still another embodiment, more battens, binders or devices capable of holding and fixing a paper on the writing member can be deposed at two or more sides of the notebook mountable hand writing memory system as the holding devices.

In the notebook mountable hand writing memory system of the present invention, the writing member consists of the top protective layer, the sensing board, and the bottom protective layer so the writing member has no need of a housing. In the notebook mountable hand writing memory system of present invention, only the digital system needs a housing. Therefore, the size and the weight of the housing which the notebook mountable hand writing memory system is reduced. Furthermore, several through holes are formed on the writing member for connecting the notebook mountable hand writing memory system with a conventional notebook. Therefore, the notebook mountable hand writing memory system has the characteristics of low weight and thinner thickness, and it can be integrated with a conventional notebook for digitizing and store the information wrote in the conventional notebook.

Although the present invention will be described in accordance with the embodiments shown above, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A notebook mountable hand writing memory system, comprising:
a digital system for controlling said notebook mountable hand writing memory system;
a pointing device for writing and inputting on a paper and said notebook mountable hand writing memory system;
a writing member for sensing said pointing device and for placing a paper thereon to write and input; and
a plurality of through holes formed on said writing member for holding a paper on said writing member by assembling said through holes and fixing rings.

2. The notebook mountable hand writing memory system of claim 1, wherein said writing member comprises a top protective layer, a sensing board and a bottom protective layer, and said sensing board is sandwiched in between said top protective layer and said bottom protective layer.

3. The notebook mountable hand writing memory system of claim 2, wherein said top protective layer and said bottom protective layer are made of a plastic material, a rubber or a silica gel.

4. The notebook mountable hand writing memory system of claim 2, wherein said bottom protective layer comprises a metal material for preventing form interference, and said metal material comprises a silicon steel, a copper foil, or both of said silicon steel and said copper foil.

5. The notebook mountable hand writing memory system of claim 2, wherein said sensing board comprises an inductive area and said inductive area has at least one inductive loop disposed therein for sensing the electromagnetic signals emitting form said pointing device.

6. The notebook mountable hand writing memory system of claim 2, wherein said digital system comprises a system member and a housing and said housing covers said system member for protecting said system member.

7. The notebook mountable hand writing memory system of claim 6, wherein said system member comprising:
a signal processing unit for processing said electromagnetic signals sensed or receed by said writing member;
a memory unit for storing the information inputted by said pointing device;
a power unit for supplying power to said notebook mountable hand writing memory system to operate; and
a signal interface unit for connecting said notebook mountable hand writing memory system with an external system or an external device.

8. The notebook mountable hand writing memory system of claim 7, wherein said system member is a control board with said signal processing unit, said memory unit, said power unit, and said signal interface unit deposed thereon.

9. The notebook mountable hand writing memory system of claim 8, wherein said control board is deposed on said sensing board.

10. The notebook mountable hand writing memory system of claim 8, further comprising a connecting member for electrically connecting said control board with said sensing board.

11. The notebook mountable hand writing memory system of claim 1, wherein said bottom protective layer supports and carries said system member and said sensing board.

12. The notebook mountable hand writing memory system of claim 8, wherein said signal processing unit is a microprocessor or a central processing unit (CPU).

13. The notebook mountable hand writing memory system of claim 8, wherein said power unit is a battery or a battery container for placing a battery thereon or therein.

14. The notebook mountable hand writing memory system of claim 8, wherein said signal interface unit is a universal serial bus interface (USB interface).

15. The notebook mountable hand writing memory system of claim 1, further comprising a holding device deposed on at least one side of said notebook mountable hand writing memory system for holding a paper on said writing member to write and input thereon by said pointing device.

16. The notebook mountable hand writing memory system of claim 15, wherein said holding device is a batten made by reversely bending one side of said notebook mountable hand writing memory system.

17. The notebook mountable hand writing memory system of claim 16, wherein said holding device is a binder deposed on one side of said notebook mountable hand writing memory system.

18. The notebook mountable hand writing memory system of claim 1, further comprising a second notebook mountable hand writing memory system, and said second notebook mountable hand writing memory system is connected with said notebook mountable hand writing memory system to form two inner pages of a notebook by a combining member made of a soft material.

19. The notebook mountable hand writing memory system of claim 1, wherein said pointing device is an electromagnetic pen, and said electromagnetic pen comprises a coil and a circuit for emitting electromagnetic signals and a marker for outputting ink to write.
